(19) United States
(12) Patent Application Publication
(10) Pub. No.: US 2025/0208407 A1
(43) Pub. Date: Jun. 26, 2025

(54) PROCESS MEASURING DEVICE AND METHOD FOR ITS OPERATION

(71) Applicant: Endress+Hauser Conducta GmbH+Co. KG, Gerlingen (DE)

(72) Inventors: Marvin Buchfink, Leonberg (DE); Manuel Schmittner, Altbach (DE)

(21) Appl. No.: 18/987,295

(22) Filed: Dec. 19, 2024

(30) Foreign Application Priority Data
Dec. 21, 2023 (DE) 10 2023 136 338.7

(51) Int. Cl. G02B 27/00; B08B 1/12; B08B 1/16; B08B 1/30

(52) U.S. Cl. CPC G02B 27/0006; B08B 1/12; B08B 1/165; B08B 1/30

(57) ABSTRACT

The present disclosure discloses a process measuring device for determining one or more physical and/or chemical process variables, comprising a sensor element for measuring the process variable and a cleaning device for cleaning deposits and accretions on an end face of the sensor element, wherein the cleaning device has a plurality of rotatable cleaning arms which are arranged to be rotatable and pivotable about the same axis of rotation.

### CROSS-REFERENCE TO RELATED APPLICATION

The present application is related to and claims the priority benefit of German Patent Application No. 10 2023 136 338.7, filed on Dec. 21, 2023, the entire contents of which are incorporated herein by reference.

### TECHNICAL FIELD

The present disclosure relates to a process measuring device according to the preamble of claim 1, and to a method for its operation.

### BACKGROUND

Sensors, e.g. optical sensors, become dirty during processes. Measuring in fluids with other sensors may also involve algae formation or air bubble formation—e.g. with ultrasonic sensors. There are cleaning options in which the cleaning is done using a cleaning element such as brushes or wipers. Both cleaning elements wear out and must be replaced at regular intervals. The replacement is time-consuming and therefore interrupts the measurement.

Typical examples of such single-arm wiper or brush systems are in DE 10 2011 078 617 A1, DE 10 2021 133 192 A1, EP 1 816 462 A1 and EP 1 488 211 A2.

The single-arm systems are thus established. However, said systems have long maintenance intervals for bristles or wiper lip replacement. Furthermore, the only systems on the market to choose from have wiper lips or bristles.

The problem is that these systems are usually in permanent contact with the surface to be cleaned. If solid particles get between the wiper and the sensor surface, said wiper can scratch the sensor surface because the solids are held in place. Furthermore, wiper lips can be gradually and permanently plastically deformed by the contact pressure without the possibility of recovery, and must be replaced more frequently.

### SUMMARY

The present disclosure therefore poses the objective, on the basis of the aforementioned prior art, to reduce the aforementioned disadvantages of the prior art.

The present disclosure achieves this object by providing a measuring device having the features of claim 1, and by a method having the features of claim 13.

A process measuring device for determining one or more physical and/or chemical process variables comprises a sensor element for measuring the process variable and a cleaning device for cleaning deposits and accretions on an end face of the sensor element.

According to the present disclosure, the cleaning device has a plurality of, at least two or more, rotatable cleaning arms which are arranged to be rotatable and pivotable about a common axis of rotation.

The use of the plurality of cleaning arms enables the extension of the maintenance intervals and is advantageous for difficult-to-access sensors. A combination of different cleaning methods can be enabled. It is conceivable to equip one arm with a calibration standard/reference for optical sensors. This allows the functionality of the optical sensor to be verified. In addition, the degree of contamination can also be determined indirectly.

The present disclosure achieves extended maintenance intervals, improved cleaning options and additional calibration options. The maintenance intervals when using two cleaning arms are advantageously even surprisingly more than twice as long as with single-arm cleaning devices.

Advantageous developments of the present disclosure are the subject matter of the dependent claims.

It is advantageous if at least one or all of the cleaning arms are designed as wipers, each comprising an elastomer lip and/or TPE lip as a cleaning element. In this variant, one cleaning arm is in contact with the cleaning surface, while a second cleaning arm can be cleaned or rinsed. Alternatively, the cleaning arm can straighten itself again due to restoring forces, which essentially regenerates the elasticity of the cleaning element.

It is advantageous if at least one or all of the cleaning arms is or are designed as a brush arm, with each comprising a bristle track as a cleaning element. Bristles also deform elastically. However, with long-term contact, permanent deformation can sometimes occur. The use of a plurality of cleaning arms counteracts this.

It is also possible that at least one or all of the cleaning arms is or are designed as a scraper arm, with each comprising a scraper bar as a cleaning element.

The cleaning arms of the cleaning device have different cleaning elements, selected from a group consisting of a scraper bar, brush arms and/or wiper. For example, a first cleaning arm may have a brush arm, and a second cleaning arm may have a wiper. It is also possible that both cleaning arms have brush arms, but with different bristles, e.g. bristle length or bristle thickness. The same applies to wipers, scrapers and/or other cleaning elements.

The cleaning device can be arranged interchangeably on the sensor element.

The measuring device can advantageously and have a peripheral attachment module for attachment to the sensor element, wherein the cleaning device is designed as a subcomponent of this attachment module. Thus, the entire cleaning device is arranged on the sensor element in an exchangeable manner, for example for the purpose of replacing the cleaning arms or the entire cleaning device.

Furthermore, the geometry of the wiper and/or the peripheral attachment module can advantageously be designed such that the cleaning arms move or can be moved from a rest position to a cleaning position in the course of one revolution with at least a partial or full rotational movement, wherein in the cleaning position, the lower edge of the wiper lip is flush with the upper edge of the end face, cleans the end face through contact of the wiper lip with the latter, and returns to the rest position.

It is advantageous if the cleaning device has an electric motor and/or pneumatic drive.

Advantageously, each of the cleaning arms can extend parallel to the end face, wherein the distance of some or all of the cleaning arms from the end face varies in extent. This allows individual cleaning arms to carry out pre-cleaning of large deposits at lower contact pressure, while other cleaning arms remove more firmly adhering biofilm at higher contact pressure.

The cleaning arms can advantageously be arranged rotationally fixed on a rotatably mounted drive shaft, with the drive shaft extending along the axis of rotation. This allows a good adjustment of the contact pressure to be achieved by axially moving the drive shaft. Furthermore, the mechanical structure is simple, and the shaft can be replaced comparatively easily in the event of a defect.

Furthermore, the drive shaft can advantageously be arranged to be linearly movable along the axis of rotation, or the drive shaft can be designed to be telescopic for adjusting a contact pressure of the cleaning element on the end face.

It is furthermore advantageous if the end face has a measuring window along which measuring signals are emitted and/or received into a medium, and wherein the cleaning arms are arranged such that each of the cleaning arms can be guided by rotation over the measuring window. The term rotation in the sense of the present disclosure also includes a partial rotation in the form of a pivoting movement. The partial rotation can take place at an angle of 20-60°.

The cleaning elements can be arranged interchangeably on a support arm of the cleaning arm. In particular, the cleaning elements can be attached to the support arm.

In one embodiment, the support arm can have a guide means, such as a guide groove or a guide strip for engaging in a complementary guide means of the cleaning element.

A first of the cleaning arms can rest against the end face, while a second of the cleaning arms is not in contact with the end face. This can then be cleaned, or it can straighten itself, whereby elastic cleaning elements in particular regenerate their restoring forces.

The measuring device can further have a protective cavity, e.g. for mechanical protection of the cleaning arm, wherein the second cleaning arm is arranged in the protective cavity.

Also according to the present disclosure is a method for operating a measuring device according to the present disclosure, wherein the cleaning device can be operated in a maintenance interval and in a cleaning interval,
wherein a cleaning arm is movable during the maintenance interval from a position outside the end face to a position in contact with the end face, and
wherein the cleaning arm is moved in partial rotation in opposite directions over the end face during the cleaning interval.

During the maintenance interval, the cleaning arm can be actively cleaned or simply realigned into a rest position to thereby counteract permanent plastic deformation.

Furthermore, the cleaning device can advantageously guide first the first cleaning arm and then the second cleaning arm over the end face during operation, in a continuous rotational movement.

Using at least one of the cleaning arms of the cleaning device and/or an additional cleaning element of the attachment module, a calibration and/or functional test of the cleaning device and/or the sensor can be carried out within the scope of the method according to the present disclosure.

Alternatively, a solid-state calibration standard can also check the functionality of a sensor, such as in the case of an optical sensor. For this purpose, it is inserted into the optical path in order to monitor/check the measurement performance and thus also the cleaning performance. A drop in measurement performance may indicate that an exchange of the cleaning elements is needed.

### BRIEF DESCRIPTION OF THE DRAWINGS

In the following, the subject matter of the present disclosure is explained in detail using an exemplary embodiment and with the aid of accompanying figures. In the figures:

FIG. 1 shows a schematic structure of an interface of a measuring device according to the present disclosure; and

FIG. 2a-2c shows schematic views of further variants of cleaning device of a measuring device.

### DETAILED DESCRIPTION

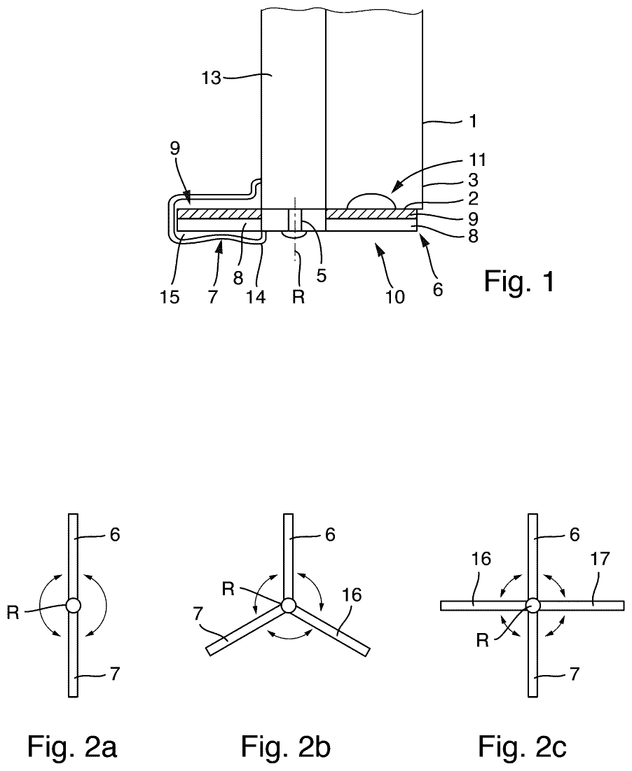

FIG. 1 is a measuring device 10 having a sensor element 1, which is sealed liquid-tight. The sensor element 1 has a terminal end face 2 in contact with the measuring medium.

The outer housing 3 of the sensor element 1 can be made of stainless steel, for example. Depending on the application, embodiments made of hard plastic, such as PVC, POM or PPS GF 40, are conceivable. The sensor element is designed for permanent residence in liquids, in particular in waste water or gases at least in a terminal subregion which also includes the end face. The outer housing typically has the shape of a straight circular cylinder. The end face 2 is positioned orthogonal to the sensor body longitudinal axis LA. However, other embodiments are conceivable; it should also be mentioned that the end face 2 can be arranged at an angle other than 90° to the sensor body longitudinal axis LA. The end face 2 also has a measuring window 11 for emitting and/or receiving measuring signals. The material of the measuring window may differ from the material of the outer housing 3 and may, for example, be a transparent material.

In the embodiment in FIG. 1, the measuring device 10 is designed to determine an optical process variable. This can be used, for example, to determine turbidity, sludge level or solids content. This can lead to an accretion of contaminants along the end face 2 coming into contact with the medium. For cleaning the end face 2, the measuring device 10 has a cleaning device 4.

The cleaning device 4 comprises a drive (not shown) as well as a drive shaft 5 mounted so as to be rotatable about an axis of rotation R. The longitudinal extension of the output shaft 5 extends along the axis of rotation R. The drive shaft 5 is located in a rotationally fixed bearing tube 13.

In FIG. 1, two cleaning arms 6, 7 extend radially away from the axis of rotation R. Each of the cleaning arms 6, 7 has at least one support arm 8 and at least one cleaning element 9 which extends parallel to the support arm 8 in its longitudinal extension.

The cleaning element 9 is arranged replaceably on the support arm 8. The cleaning element 9 can be simply pushed on, for example via a keder which lies in a corresponding groove of the support arm 8. Alternatively, a dovetail groove connection can be provided between the support arm 8 and the cleaning element. Other plug-in connections are also conceivable. With a plug-in connection, there is a positive connection between the support arm 8 and the cleaning element 9 parallel to the axis of rotation R.

As can be seen in FIG. 1, a first of the cleaning arms 6 rests on the end face, while the second of the cleaning arms 7 protrudes in the radial direction relative to the sensor element 1. As a result, the cleaning arm 7 can be damaged by the medium pressure, entrained solids such as grit or the like, or other effects. For mechanical protection, the measuring device 10 has a protective enclosure 14 which is fixed to the bearing tube 13 and which defines a protective cavity 15. The protective enclosure 14 can be made of a metal sheet. The protective enclosure can also be a mesh cage or the like. The second cleaning arm 7 is arranged within the protective enclosure 14. Despite mechanical protection, it is possible to flush the cleaning arm 7 with the measuring medium and thus clean the cleaning element 9.

The cleaning element 9 can be a lip, e.g. a rubber lip, a brush and/or a scraper.

It is possible to achieve cleaning optimization through various cleaning elements.

The distance of the cleaning elements 9 to the end face can also be different and/or adjustable. This allows the end face to be cleaned with different contact pressures. For this purpose, the drive shaft can be moved along the axis of rotation and fixed at different positions on this axis of rotation R. Alternatively or additionally, the drive shaft 5 can be designed as a telescopic shaft, or the cleaning arms 6 and 7 can be arranged at fixed but different distances from each other relative to the end face 2.

The cleaning device 4 can be driven by an electric motor and/or pneumatically. One or more fixing elements can be provided between the cleaning device 4 and the sensor element 1, said elements being designed for releasably fixing the two parts of the measuring device.

In principle, the cleaning device 4 can, however, also be used to clean the end face of a sensor body of a measuring device 10 for non-optical process variables.

In summary, FIG. 1 shows a multi-wiper unit with a plurality of wiper arms. Also conceivable are 2, 3, 4, . . . evenly arranged arms 6, 7, 16, 17 per unit, as shown in FIG. 2a-c. Each arm can be equipped in any way, e.g. a mixture of bristles, lips, scrapers or even just one of the variants, but a plurality thereof.

Cleaning can always be carried out with the wiper arm 1 for the first maintenance interval and then with the wiper arm 2 until the service life is reached in this case as well.

The advantage is a 2 . . . x-fold increase in time until replacement compared to the known single-arm solution. By using different cleaning attachments, cleaning processes tailored to the process are possible, e.g. scraper, bristle, wiper lip at a customized frequency, such as one after the other. It is possible to either wipe back and forth from one wiper arm position or to move in circles with all wiper arms.

It is also conceivable to attach a solid-state calibration standard for optical sensors to an arm in order to test and/or calibrate the functionality of the sensor and to monitor the result of the cleaning.

1. A process measuring device for determining one or more physical and/or chemical process variables, comprising:
a sensor element for measuring the process variable and a cleaning device for cleaning deposits and accretions on an end face of the sensor element;
wherein the cleaning device has a plurality of rotatable cleaning arms which are arranged to be rotatable and pivotable about a common axis of rotation.

2. The measuring device according to claim 1,
wherein at least one or all of the cleaning arms is or are designed as a wiper;
at least one or all of the cleaning arms is or are designed as a brush arm; or
at least one or all of the cleaning arms is or are designed as a scraper arm.

3. The measuring device according to claim 1,
wherein at least one of the cleaning arms has a solid-state calibration standard for calibrating and/or checking the cleaning device and/or the sensor element.

4. The measuring device according to claim 1,
wherein the measuring device has a peripheral attachment module for attachment to the sensor element;
wherein the cleaning device is designed as a subcomponent of this attachment module.

5. The measuring device according to claim 1,
wherein the geometries of the wiper and/or the peripheral attachment module are designed such that the cleaning arms move from a rest position to a cleaning position in the course of one revolution with at least a partial or full rotational movement;
wherein in the cleaning position, the lower edge of the wiper lip is flush with the upper edge of the end face of the sensor element, cleans the end face through contact of the wiper lip with the latter, and returns to the rest position.

6. The measuring device according to claim 1,
wherein the cleaning device has different cleaning elements on the cleaning arms.

7. The measuring device according to claim 1,
wherein each of the cleaning arms extends parallel to the end face, wherein the distance of the cleaning arms to the end face varies.

8. The measuring device according to claim 1,
wherein the cleaning arms are arranged in a rotationally fixed manner on a rotatably mounted drive shaft, and wherein the drive shaft extends along the axis of rotation;
wherein the drive shaft is arranged to be linearly movable along the axis of rotation, or the drive shaft is designed to be telescopic to adjust a contact pressure of the cleaning element on the end face.

9. The measuring device according to claim 1,
wherein the cleaning elements are arranged interchangeably on a support arm of the cleaning arm, wherein the cleaning element is attached on the support arm.

10. The measuring device according to claim 9,
wherein the support arm has a guide groove or a guide strip for engaging in a complementary guide feature of the cleaning element.

11. The measuring device of claim 1,
wherein a first of the cleaning arms rests on the end face, while a second of the cleaning arms is not in contact with the end face.

12. The measuring device according to claim 1,
wherein the measuring device has a protective cavity, wherein the second cleaning arm is arranged in the protective cavity.

13. A method for operating a measuring device, wherein the measuring device includes a sensor element for measuring the process variable and a cleaning device for cleaning deposits and accretions on an end face of the sensor element, wherein cleaning device has a plurality of rotatable cleaning arms which are arranged to be rotatable and pivotable about a common axis of rotation, the method including:
operating the cleaning device in a maintenance interval and a cleaning interval;
wherein a cleaning arm is movable during the maintenance interval from a position outside the end face to a position in contact with the end face, and
wherein the cleaning arm is moved in partial rotation in opposite directions over the end face during the cleaning interval.

14. The method according to claim 13, wherein the cleaning device, during operation, in a continuous rotational movement, first guides the first cleaning arm and then the second cleaning arm over the end face.

15. The method according to claim 13, wherein using at least one of the cleaning arms of the cleaning device and/or an additional cleaning element of the attachment module, a calibration and/or functional test of the cleaning device and/or the sensor can be carried out.
